(19) United States
(12) Patent Application Publication
(10) Pub. No.: US 2003/0021032 A1
(43) Pub. Date: Jan. 30, 2003

(54) Method and system to display a virtual input device

(76) Inventors: Cyrus Bamji, Fremont, CA (US); Peiqian Zhao, Palo Alto, CA (US)

Correspondence Address: DORSEY & WHITNEY LLP, Suite 3400, Four Embarcadero Center, San Francisco, CA, 94111-4187, US

(21) Appl. No.: 10/179,452

(22) Filed: Jun. 24, 2002

Related U.S. Application Data
(60) Provisional application No. 60/300,542, filed on Jun. 22, 2001.

(51) Int. Cl. G02B 5/18

(52) U.S. Cl. 359/568; 359/558

(57) ABSTRACT

A system to project the image of a virtual input device includes a substrate bearing a diffractive pattern, and a source of collimated light, such as a laser diode. The collimated light interacts with the substrate and the pattern to project a user-viewable image that preferably is the image of a virtual input device. Interaction between a user and the projected image of the virtual input device can then be sensed, and used to input information or otherwise control a companion device, for example a PDA or a cellular telephone.

### RELATIONSHIP TO CO-PENDING APPLICATION

This application claims priority to U.S. provisional patent application filed on Jun. 22, 2001, entitled “User Interface Projection System”, application Ser. No. 60/300,542.

### FIELD OF THE INVENTION

The invention relates generally to electronic devices that can receive information by sensing an interaction between a user-object and a virtual input device, and more particularly to a system to project a display of a virtual input device with which a user can interact to affect operation of a companion electronic device.

### BACKGROUND OF THE INVENTION

Many mobile electronic devices have a small form factor that often renders user-input of data or other information cumbersome. For example a PDA or a cell telephone may allow the user to input data and other information, but the absence of a truly useable keyboard can make such user input rather difficult. Some systems provide a passive virtual input device, for example a full or nearly-full sized keyboard and then sense the interaction of a user-controlled object (e.g., a finger, a stylus, etc.) with regions of the virtual input device. For example, U.S. Pat. No. 6,323,942 to Bamji et al. (2001) entitled “CMOS-Compatible Three-dimensional Image Sensor IC” discloses a time-of-flight system that can obtain three-dimensional information as to location of an object, e.g., a user's fingers or other user-controlled object. Such a system can sense the interaction between a user-controlled object and a passive virtual input device, e.g., an image of a keyboard. For example, if a user's finger “touched” the region of the virtual input device where the letter “L” would be placed on a real keyboard, the system could detect this interaction and output key scancode information for the letter “L”. The scancode output could be coupled to a companion electronic system, perhaps a PDA or cell telephone. In this fashion, user-controlled information can be sensed from a virtual input device, and used to control operation of a companion device.

While the user might be provided with a paper template of the virtual input device, e.g., a keyboard or keypad, to help guide the user's fingers or stylus, the template might become lost or misplaced, or damaged. What is needed is a system and method by which a user-viewable image of a virtual input device can be generated optically, for example, by projection.

Attempts have been made in the prior art to project images with which a user might attempt to interact. For example, C. J. Taylor has described projecting a pattern on a flat surface to enable a user to interact with the projected image by blocking image portions with the user's hand. Taylor disposes an image projector and a camera on the same side of the projection surface and regards blocked image portions as representing user selections. Taylor's method appears to require a high light output projector (probably an LCD projector or a traditional slide projector) to present the image.

Understandably, a Taylor-like scheme is hardly applicable for use with battery-powered devices such as a PDA, or a cell telephone. Even if the power required by Taylor to project an image were not prohibitive, the form factor of Taylor's projection system would itself exclude true portable operation. In addition, the user's hand will occlude portions of Taylor's projected image, thus potentially confusing the user and rendering the overall projection system somewhat counter-intuitive. Further, Taylor's system cannot readily discern between a user-controlled object placed over an image of the virtual input device, and the same user-controlled object placed on the plane of the image, e.g., “touching” the image. This inability to discern can give rise to ambiguous data or information in many applications, e.g., where the input device is a virtual keyboard. In fact, Taylor suggests that users “wiggle” their finger to better enable detection of a triggering keystroke event.

There is a need for a system to project a virtual input device that has a small enough form factor to be disposed within the companion electronic device, e.g., PDA, cell telephone, etc., with which the virtual input device is intended to be used. Preferably such a projection system should be relatively inexpensive to implement, and should have modest power requirements that permit the system to be battery operable. Finally, such system should minimize visual occlusions that can confuse the user, and that might result in ambiguously sensed information resulting from user interaction with the projected image.

The present invention provides such a method and system to generate an image of a virtual input device.

### SUMMARY OF THE INVENTION

A system to project the image of a virtual input device preferably includes a substrate having a diffractive pattern and a collimated light source, e.g., a laser diode. Emitted collimated light interacts with the diffractive pattern in the substrate, with the result that a user-visible light intensity pattern can be projected. Collectively, a substrate-pattern component is referred to herein as a diffractive optical element or “DOE”. In one embodiment, the substrate diffractive pattern causes an image of a keyboard or keypad virtual input device to be projected. The projected image helps guide the user in positioning a user-controlled object relative to the virtual input device, to input information to a companion electronic device. Advantageously the use of a diffractive pattern reduces the amount of light source illumination proportionally to the illuminated area of the pattern, e.g., the line images that make up the projected image, rather than to the total area of the projected image. The projection system exhibits a small form factor, low manufacturing cost, and low power dissipation. The projection system may be fabricated within a companion electronic device, input information for which is created by user interaction with the projected image of the virtual input device.

Relatively inexpensive diffractive optical components that are characterized by an undesirably narrow projection angle are used in several embodiments to create a sharply focused composite projected user-viewable image. These embodiments compensate for the too-narrow projection angle of a single diffractive optical element using beam expanding techniques that include creating the projected image as a mosaic or composite of the collimate output from several narrow-angle elements. In some embodiments merged diffractive optical components are used in which a diffractive lens function and the diffractive pattern function are built into a single element, which may include several such lens and pattern functions to create a composite projected image.

Point light sources preferably are inexpensive LED devices, and the projection effect of multiple sources may be synthesized with a half-mirror that creates an imaginary image of a real light source, and with a half collimating lens that creates collimated groups of light beams from the real and from the imaginary light sources. Spatial filter techniques to improve the quality of images resulting from inexpensive LED sources are disclosed, as is a technique enabling scoring of a substrate containing a plurality of diffractive patterns, which are otherwise invisible to dicing machinery used to cut apart the substrate. Artifacts such as ghosting and zero order dot images are may be reduced by blocking light rays that create such artifact images, while not disturbing projection of the intended image. Finally, the separation of multiple DOEs formed on a common substrate is simplified by defining separation channel areas on the substrate that will be visible, as cutting guides, once the substrate has been processed.

Other features and advantages of the invention will appear from the following description in which the preferred embodiments have been set forth in detail, in conjunction with the accompanying drawings.

### BRIEF DESCRIPTION OF THE DRAWINGS

FIG. 1 is a left side view of a generic three-dimensional data acquisition system equipped with a system to generate a virtual input device display, according to the present invention;

FIG. 2 is a plan view of the system shown in FIG. 1, according to the present invention;

FIG. 3 depicts exemplary generation of a desired user-viewable display, according to the present invention;

FIG. 4A depicts an optically collimated projection system, according to the present invention;

FIG. 4B depicts a projection system in which collimating and focusing functions are merged into a single optical element, according to an alternative embodiment of the present invention;

FIG. 5A depicts a beam expanding embodiment using a single relatively narrow projection angle diffractive optical element to provide a large offset collimated beam with which to project an image over a large projection angle, according to the present invention;

FIG. 5B depicts an embodiment in which an array of optical elements is used with a single light source to provide groups of separated collimated beams including beams with a large angular offset used with DOEs to project an image over a large projection angle, according to the present invention;

FIG. 5C-1 depicts an embodiment in which collimated light beams are input to a splitting-prism whose optical output includes sets of collimated light beams with a large angular offset used with DOEs to project an image over a large projection angle, according to the present invention;

FIG. 5C-2 depicts an embodiment in which collimated light beams are input to a splitting-prism whose optical output includes sets of collimated light beams with a large angular offset used with DOEs that can be merged into the splitting prism to project an image over a large projection angle, according to the present invention;

FIG. 5D depicts an embodiment in which collimated light beams are input to a splitting DOE whose optical output includes sets of collimated light beams having immediate large angular offset but deferred spatial separation, with which to project an image over a large projection angle, according to the present invention;

FIG. 5E depicts an embodiment in which a single collimating optic element responds to light from multiple point sources and outputs sets of collimated light beams having immediate large angular offset but deferred spatial separation, with which to project an image over a large projection angle, according to the present invention;

FIG. 5F depicts a pseudo-dual light source embodiment in which one real light source is mirrored to create a second, virtual image, light source, and a half-lens collimating optic elements outputs sets of collimated light beams with a large angular offset, with which to project an image over a large projection angle, according to the present invention;

FIG. 6A depicts an embodiment in which spaced-apart composite DOEs perform collimated beam splitting and user-viewable pattern projection to project an image over a large projection angle according to the present invention;

FIG. 6B depicts an embodiment in which a single composite DOE performs the collimated beam splitting and user-viewable pattern projection in a single element to project an image over a large projection angle according to the present invention;

FIGS. 7A depicts an embodiment in which nearly-collimated light and spatial filtering reduces the effective aperture of an LED light source used to project a user-viewable image, according to the present invention;

FIG. 7B is an embodiment similar to the spatial filtering embodiment of FIG. 7A, but in which the LED light source lens replaces a separate imaging lens, according to the present invention;

FIG. 7C is an embodiment in which a portion of the projection system mechanically pops-up to create a beam path through free space to emulate the presence of a large (e.g., 2 cm) focal length optical system, to project a user-viewable image, according to the present invention;

FIGS. 8A-8D depict image artifacts and ghosting including zero order dot imaging, as may be occur absent preventative measures when projecting user-viewable images, according to the present invention;

FIG. 9A depicts light beams associated with the projection of a ghost image, zero order dot, and desired image for the configuration of FIG. 8C, according to the present invention;

FIG. 9B depicts blocking to eliminate the ghost image and zero order dot while leaving a desired projected image for the configuration shown in FIG. 9A, according to the present invention; and

FIG. 10 depicts fabrication of a semiconductor die with a plurality of DOEs and inclusion of guide channels for use in cutting apart the individual DOEs, according to the present invention.

### DETAILED DESCRIPTION OF THE PREFERRED EMBODIMENTS

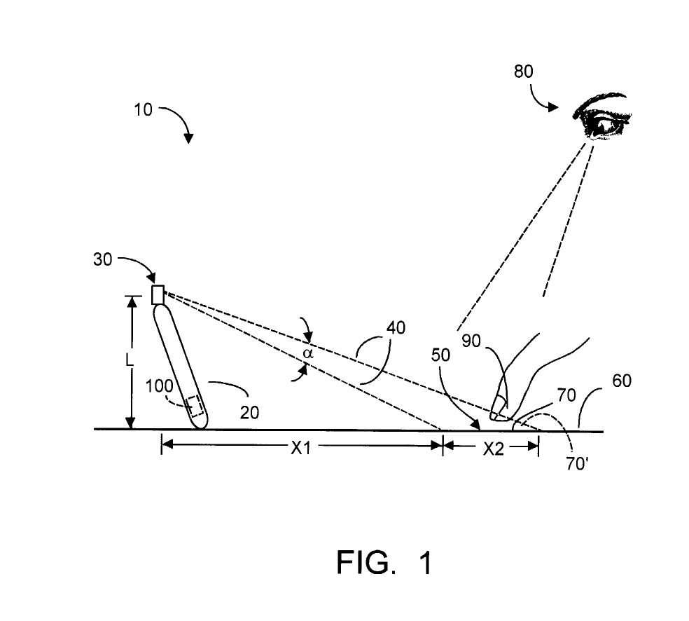

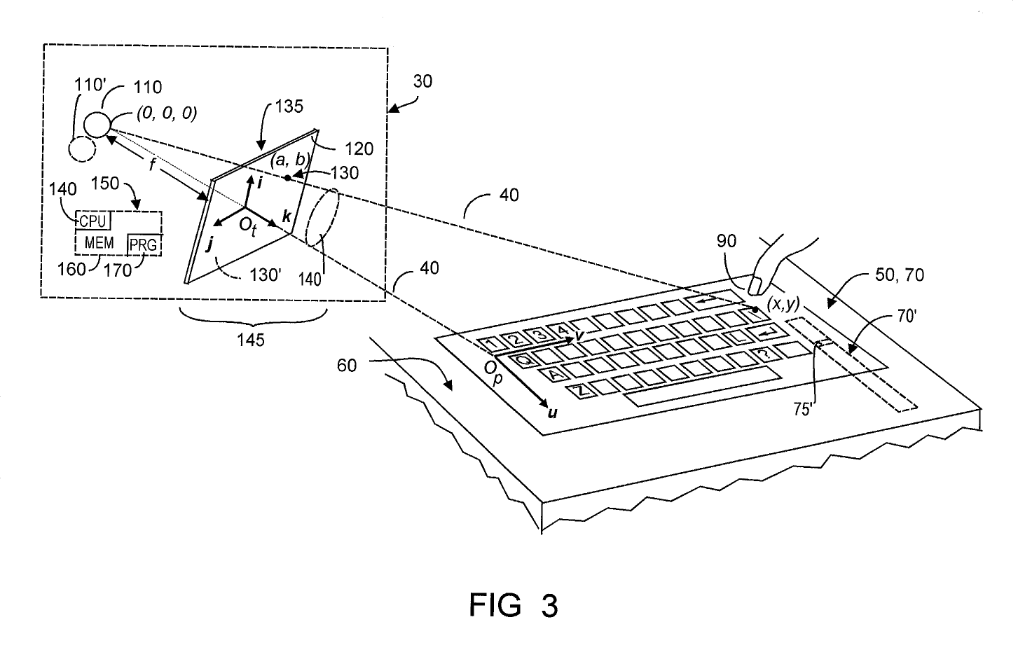

FIG. 1 is a left side view depiction of a system 10, that includes a companion electronic device 20, a system 30 that projects visible light 40 to form an image 50 on a preferably planar surface 60, perhaps a table or desk top. Image 60 preferably depicts a virtual input device 70, for example a keyboard, a keypad, a slider control, or the like. FIG. 1 depicts a projected user-viewable image of a virtual keyboard 70 as well as a projected image of a virtual slider control 70′, shown in phantom line (see also FIG. 3.)

Virtual input device 70 is visible to the eye 80 of a user, who manipulates a finger or other user-controlled object 90 to interact with the virtual input device. For purposes of the present invention, it suffices to assume that device 20, which may be a PDA, a computer, a cell telephone, among other devices, includes a sub-system 100 that allows device 20 to recognize the interaction between user-controlled object 90 and the virtual input device 90. Without limitation, U.S. Pat. No. 6,323,942 to Bamji et al. (2001) may be implemented as sub-system 100.

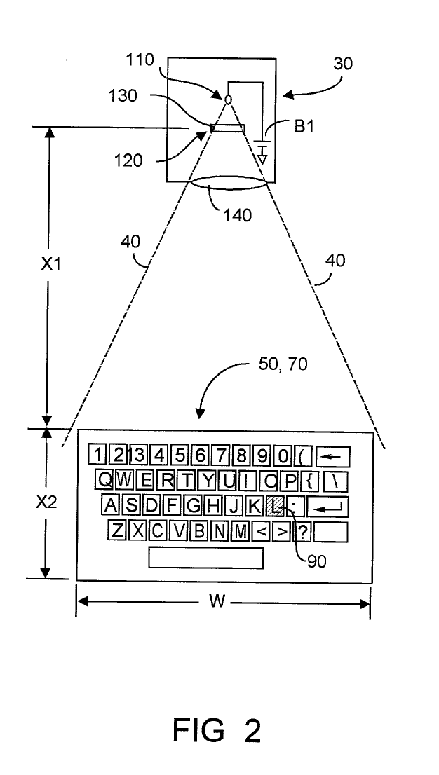

Regardless of how sub-system 100 is implemented, the sub-system can identify and quantize user interaction with projected image 70. For example, if the virtual input device is a computer keyboard, then image 70 preferably appears to the user's eye as the outline of a keyboard. As best seen in FIG. 2, image 70 would show “keys” bearing “legends” such as “Q”, “W”, “E”, “R” etc. As the user moves object 90 to “touch” a projected “key” image, sub-system 100 will recognize the user interaction and can input a suitable result signal for use by device 20. For example, if the user “touched” the “A” key on the projected image of a virtual keyboard, then sub-system 100 could input a scancode for the letter “A” to device 10. If the projected image were, say, a slider-control 70′, the user could “move” the control slider 75′, e.g., up or down in FIG. 1, using object 90. Sub-system 100 would recognize this user-interaction and respond to by commanding device 20 in an appropriate manner. Without limitation, user interaction with a virtual slider control 70′ may be used to change audio volume of a companion device, and/or size of an image, or selection of a menu item, and so forth.

Thus, the present invention is directed to a system 30 that can project a user-viewable image 50 that can include a virtual input device 90 with which a user can interact with a user-controlled object 90. Although dimensions are not necessarily critical, dimension L might be about 8 cm to about 14 cm with 12 cm representing a typical height, dimension X1 might be about 8 cm to about 15 cm with perhaps 10 cm being a typical dimension, and the “front-to-back” projected dimension X2 of the virtual input device might be about 8 cm to about 15 cm. It will be appreciated from the exemplary dimensions that the configuration of FIG. 1 is inherently user-friendly. If companion electronic device 20 is a PDA, for example, its front surface may include a display that provisions visual feedback to the user. Thus, if virtual device 70 is a projected computer keyboard, and the user interfaces with the virtual keyboard letter “L”, the display on device 20 can show the letter “L” as having been entered. If desired, electronics 100 associated with device 20 could audibly enunciate each keystroke event generated by user-interface with virtual device 70, or could otherwise audibly signal the detected keystroke event. If the virtual device is, for example, a slide control 70′, user-interaction with the “movable” portion 75′ of the control could be evidenced by companion device 20.

Turning now to FIG. 2, a planar view of system 30 and the projected virtual input device image is shown. In the example shown, projected image 50 is a computer keyboard input device 70. As such, a user viewing the projected image will see, outlined in visible projected light, images of keyboard keys and indeed, if desired, the outline perimeter of the overall keyboard itself. In FIG. 2, the distal portion of the user-controlled object 90, perhaps the user's fingertip, is shown as being over the location of the “L” key on the virtual keyboard. In FIG. 2, the left-to-right width W of the projected keyboard image might be on the order of about 15 cm to 30 cm or so, with 20 cm representing a typical width. It will be appreciated that, if desired, the projected image 50 of the virtual input device 70 may in fact be sized to approximate a full-sized such input device, e.g., a computer keyboard.

In FIG. 2, the area X2@W defines the overall pattern area, for example perhaps 175 cm². Advantageously, the fraction of the overall area that must be illuminated with energy from source 110 is a small percentage of the overall area. For example, the effective illuminated area will be proportional to the thickness and the length of the various projected lines, e.g., the perimeter length of the “box” surrounding the letter “L” times the thickness of the projected line defining the “box”, plus the area of the lines defining the letter “L” within. It is understood that the user-viewable image will comprise closely spaced regions (ideally dots although in practice somewhat blurred dots) of projected light. In practice, the illuminated area is about 10% to 15% of the overall area defined by the virtual keyboard. Within system 30, the size of the diffractive pattern 130 defined on or in substrate 120 may be on the order of perhaps 15 mm², and overall efficiency of the illumination system can be on the order of about 65% to about 75%. Understandably using thin user-viewable indicia and “fonts” that appear on virtual keyboard keys can further reduce power consumption. As noted later herein, additional power efficiency can be obtained by pulsing light source 1 10 so as to emit light only during intervals when a projected image is actually required to be viewed by a user.

If desired, emissions from source 110 can be halted entirely during periods of user non-activity lasting more than a few seconds to further conserve operating power. Such inactivity by the user can be sensed by the light sensor system associated with companion device 20 and used to turn-off or at least substantially reduce operating power provided to light source 110, e.g., under command of sub-system 150. In this fashion, the user-viewable image 50 of the virtual input device 70 can be dimmed or even extinguished, to save operating power.

In FIG. 2, system 30 preferably includes a light source 110 whose visible light emissions pass at least partially through a substrate 120 that bears a diffractive pattern 130. Preferably light source 110 is a collimated light source or substantially collimated light source, for example a laser diode although a light emitting diode (LED) with a collimator could be used. LEDs have advantages over laser diodes for use as light source 110, including a savings of about 90% in cost, better robustness and ease of driving with simple drive circuits, as well as freedom from eye safety issues. Further, inexpensive LEDs are readily available with a spectral output to which the human eye is especially sensitive. However, as described later herein, the successful use of LEDs to project a sharply focused image using diffractive optics requires compensating for the relatively large LED aperture size (perhaps 200 μm×200 μm compared with only 5 μm×5 μm for a laser diode) and compensating for a relatively impure wide spectral band of emission, which can cause large spot size at the periphery of a projected image such as a virtual keyboard. An alternative light source is a so-called resonant cavity LED (or RCLED), a device that can emit a spectrum of light include 600 nm radiation. RCLEDs can provide acceptable 40 μm emitting size, are less expensive than a laser diode and advantageously emit light from the device front, which permits optically processing right on the device itself.

Referring still to FIG. 2, those skilled in the art will appreciate that pattern 130 in substrate 120 will not per se “look” like the outline of a virtual keyboard with keys or even a portion of that image (if the output from several patterns 130 is combined to yield a composite projected image). However the interaction between the collimated light energy radiating from light source 110 and the diffractive pattern 130 formed in substrate 120 is such that a pattern of lines will be projected onto surface 60 to define the image 50 of a virtual input device 70. In an ideal world, the projected regions would comprise tiny dots of light, although in practice some blurring of dot size is commonly experienced. As described herein, it may be desired to form the projected image as a composite or mosaic of several smaller sub-images, e.g., to promote overall image sharpness. As noted in FIG. 2, preferably system 30 is low power and can operate from a battery B1 disposed within the system, or within companion device 30. A typical magnitude for B1 might be 3 VDC. Further savings in power consumption can be realized by operating light source 110 in a pulsed mode, perhaps at a repetition rate of 10 Hz to perhaps 1 KHz. Indeed, depending upon the frequency, pulsed lighting can actually appear to be brighter than lighting with 100% duty cycle, which phenomenon is known as the Broca-Sultzer effect. Furthermore, a flickering pattern may be more readily distinguished from background light. Repetition rates of 10 Hz to perhaps 1 KHz are readily achievable with a laser diode or LED as light source 110. Repetition rate and/or duty cycle of operating power to light source 110 can be controlled using a microprocessor or a CPU, such as 140 (see FIG. 3), or perhaps by a user-operable control associated with companion device 20. In FIG. 3, microprocessor 140 may be associated a processing sub-system 150 that includes memory 160 (persistent and/or volatile memory) into which software 170 may be stored or loaded for execution by CPU 140. Thus, software 170 may be used to command repetition rate and/or duty cycle of operating power coupled to light source 110. Pulsing the light source is an effective mechanism to control brightness of the user-viewable display. Understandably the display should be sufficiently bright to be seen by the user, but need not be overly bright. If desired, in the absence of any detected user interaction with virtual input device 70, processing sub-system 150 could be used to dim and/or extinguish light output 40 from light source 110. When user interaction is again detected, either by companion device 20 or by dedicated go/no-go user presence detection function executed by sub-system 150, light source 110 can again be provided with normal or at least increased operating power.

It will be appreciated that any portion of the projected image that is masked by the user-controlled object 90 will not, in practice, be viewable from the user's vantage point. For example, as object 90 comes close to the area of a projected region, perhaps the region defining the “L” key, the pattern of projected light may now projected onto object 90 itself, but as a practical matter the viewer will not see this. Ambiguity, to the user or to system 100, that might confuse location of the user interface with the virtual input device image, is absent, and a proper keystroke event can occur as a result of the interface.

FIG. 3 depicts some general considerations involved in providing a substrate 120 bearing a suitable diffractive pattern 130 to achieve a desired projected user-viewable image 50 of a desired virtual input device 70. The term diffractive optical element or “DOE” 135 will be used to collectively refer to substrate 120 and diffractive pattern 130. As noted, light source 110 is preferably a small device, e.g, a laser diode, an LED, etc., perhaps emitting visible optical energy whose wavelength is perhaps 630 nm. Generally speaking, light source 110 should emit about 5 mW to 10 mW of optical power, to render a projected image 50 of the virtual input device 70 that has higher contrast, perhaps four or five times higher, than ambient light. In practice, about 500 lux emitted optical energy may suffice. A generic red laser diode can fulfill these design goals relatively inexpensively and in a small form factor. In general, light beams exiting DOE 135 can produce a field at infinity, and the feature size or dot size of an image projected by DOE 135 will be the width of the collimated light beams producing the image.

The geometry of the image of the virtual input device should be amenable for projection. For a given DOE position and given maximum deflection angle, in practice the attainable range of illumination from source 110 and/or 110′ will be a cone centered at the DOE. The intersection of this cone with the work surface 60 will define a shape such as an ellipse or hyperbole, and the projected image should fit within this shape. In practical applications, this shape will be similar to a hyperbole.

A coordinate transformation is necessary to compute the spatial image generated by pattern-generating system 30 to project the desired user-visible image 70 on flat surface 60. Once appropriate pattern 130 has been computed, it can be etched or otherwise created in substrate 120. Collimated light from light source 110 is trained upon diffractive substrate 120, preferably glass, silica, plastic or other material suitable for creating a diffractive optics pattern. In the presence of such light, diffractive patterned material 120 creates a light intensity pattern that may be shaped to project the outline of a user interface image 50, for example the outline image of a virtual keyboard, complete with virtual lettered keys.

In practice, one can first define the shape of the desired projected user-visible image 50, 70 and then employ a mathematical derivation to calculate the necessary shape of the pattern 130 to be etched or otherwise formed in the diffractive substrate 130.

In FIG. 3, assume that light source 110 defines the origin of a world reference system and let f be the distance from light source 110 to the plane of substrate 120. On substrate plane 120, a reference system is defined whose origin Oₜ is at a location on the substrate nearest light source 110. A unit vector k=(0, 0, 1) is used to identify a normal to substrate plane 120, and two orthogonal unit vectors i,j will define the axes of a reference frame on the frame of the substrate. A line from light source 110 through origin Oₜ will meet the desired projection plane (on which appear 50, 70) at an origin point Oₚ, which defines the origin of a reference frame on the projection plane. In FIG. 3, the axes of this reference plane are identified by orthogonal unit vectors u and v.

In substrate 120 plane coordinates, coordinates (a,b) will represent a diffractive pattern point that will project to a point having projection-plane coordinates (x, y). The necessary (a,b) coordinates may be given as:

$$[ \begin{matrix}a \\ b\end{matrix} ] = f [ \begin{matrix}\frac{{p}_{x}}{{p}_{z}} \\ \frac{{p}_{y}}{{p}_{z}}\end{matrix} ]$$

$$where \\ [ \begin{matrix}{p}_{x} \\ {p}_{y} \\ {p}_{z}\end{matrix} ] = [ \begin{matrix}{i}^{T} \\ {j}^{T} \\ {k}^{T}\end{matrix} ] [ \begin{matrix}u & v & k\end{matrix} ] [ \begin{matrix}x \\ y \\ d\end{matrix} ]$$

and where d is the distance from light source 110 to origin Oₚ of the projection plane, and where superscript T denotes transposition. Without loss of generality, unit axes i and j can be selected to coincide with the world reference axes. In this case, the matrix:

$$[ \begin{matrix}{i}^{T} \\ {j}^{T} \\ {k}^{T}\end{matrix} ]$$

is equal to the identity matrix, and can be omitted.

For ease of explanatory proposes, the description given herein will be centered around a slide-like projection system that has no lens, although in practice, an actual system will typically include a lens. Further, patterns etched in a DOE will correspond to diffraction angles rather than to locations on the DOE such as location (a,b). However finding the diffraction angles from point (a,b) is trivial. Let P denote the point in three-dimensional coordinate space that corresponds to location (a,b) on the substrate. The diffraction angle for point (x,y) on the table is then given by vector OP, where O is the origin of the coordinate system (0,0,0) in FIG. 3.

Although FIGS. 1-3 depict the present invention used to present a user-viewable image of a virtual keyboard, or slide control (FIG. 3), other images can also be created. For example, a key-pad only portion of virtual keyboard 70 could be presented. Instead of a virtual input device with computer-like keys, image 70 could represent a musical instrument, for example a piano keyboard. Image 70 may be a musical synthesizer keyboard that can include slide-bar controls. When such a control is “moved” by a user-object “sliding” the virtual movable portion, the effect can be to vary an output parameter associated with companion device 30. Companion device 30 may be an acoustic system, that plays music when a user interacts with projected virtual keyboard keys, and that perhaps changes audio volume, bass, treble, etc. when the user interacts with virtual controls, including slide-bar controls.

As noted, the physical pattern area 130 associated with a desired projected virtual input device image is quite small, on the order of a few mm². Thus, a single substrate 120 could carry a plurality of patterns 130, including without limitation a virtual English language keyboard, various foreign language keyboards, musical instruments, and so forth. Alternate pattern 130′, shown in phantom in FIG. 3 may be understood to depict such pattern(s). A simple mechanical device could be used to permit the user to manually select the pattern to be generated at a given time. Alternatively, dynamic diffractive patterns under software control commanded by sub-system 150 (see FIG. 3) may be used to enable pattern choices and pattern changes. For example, pattern 130 could be used to project the image of a virtual keyboard 70, and/or pattern 130′ could be used to project some other image, e.g., a virtual slide control 70′. Alternatively, such generation of different patterns could be implemented using a microprocessor and memory associated with companion system 20.

As an alternative to using system 30 to generate a user-viewable image using diffractive pattern techniques, substrate 120 and pattern(s) 130, 130′ could be omitted, and instead light source 110 could be scanned, under control of sub-system 150 (see FIG. 3) to “paint” the desired image 50, 70 upon surface 60. Understandably such a scanning system would add complexity, cost, and package size to the overall system.

If desired, another embodiment of the present invention omits substrate 120 and pattern(s) 130, and instead provides a two-dimensional array of light sources e.g., 110, 110′. Such an array of light sources, preferably LED or laser diodes, could be fabricated upon a single integrated circuit substrate using existing technology, e.g., VCEL fabrication techniques. Light emitted from such light sources would be focused upon surface 60, using lenses 140, if needed, to provide the user-viewable image 50 of a virtual input device 70, 70′.

Operating power can be enhanced by partitioning the array pattern of light sources 110, 110′ into blocks. Under control of sub-system 150 portions of these blocks may be dimmed or turned-off if the corresponding portion of the user-viewable image 70, 70′ was not relevant at the particular moment. Preferably the array and array portions are fabricated on a common integrated circuit laser die, such that all VCELs can share a common collimating optic system, e.g., 140. It is understood that by virtue of spacing within the array of light emitters 110, 110′, different portions of the diffractive optics could be illuminated by different portions of the array of emitters.

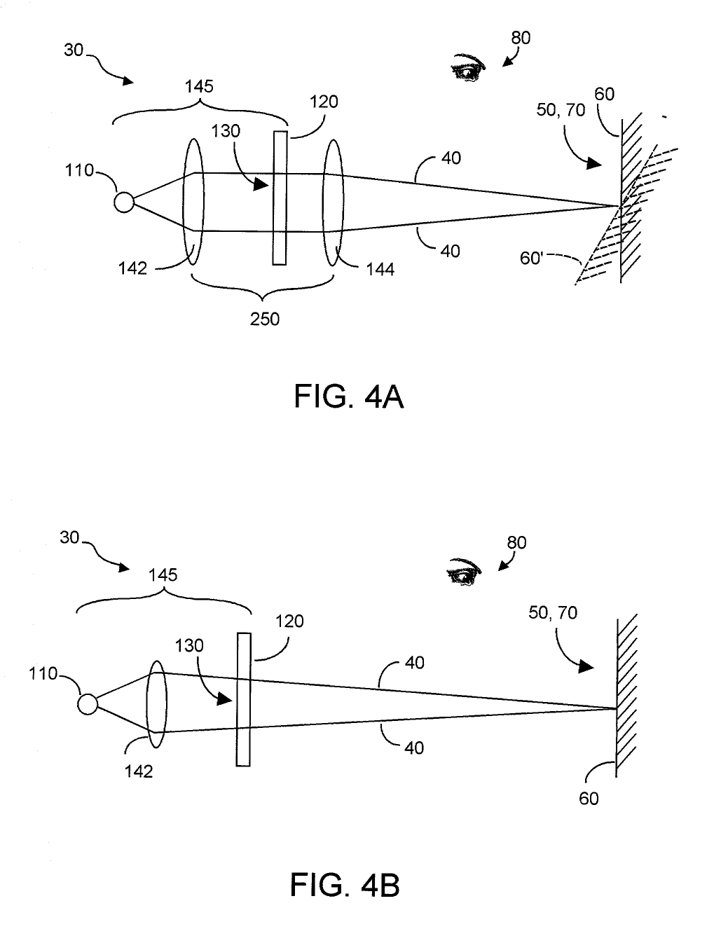

Beginning now with FIG. 4A, a further description of diffractive optics and various embodiments for successfully projecting an image (e.g., of a virtual input device) will now be given. Diffractive optics require illumination with a collimated light source, and collimating, which may require at least one lens 140, can generate light beams 40 that are ideally parallel to each other. In one embodiment, the present invention uses collimating optics 140 that can be incorporated with the diffractive optic substrate 120 to yield an optical system 145. Optical system 145 has relatively few optical components and preferably is implemented as a single optical component.

Assume that light source 110 outputs light energy in the 10 mW range. On one hand, using of an LED to implement light source 110 is preferred from a cost standpoint to use of a laser diode. But the effective emitting area of an LED light source 110 is on the order of perhaps 300 μm×300 μm, an area substantially greater than the perhaps 5 μm×5 μm effective area of a laser diode light source 110. Thus, while LEDs are inexpensive light sources, from an effective emitting area standpoint, LED emissions are not as readily collimated as emissions from a laser diode.

It is known in the art that light sources that have an extended emitting area such as LEDs are more difficult to collimate than sources such as laser diodes, which have a smaller emitting area. Thus, use of an LED light source 110 may tend to produce a smeared user-viewable image 50, even at the distances of interest X1. Collimating can be improved by increasing the beam width, e.g., which is to say by increasing the focal length of collimating lens 140. But increasing the light source beam width also tends to produce a smeared image 50. However smearing effects due to beam width can be substantially reduced, if not removed, by refocusing the output beam 40 from the diffractive optics 120 onto projection surface 60, a known distance from the diffractive optics (see FIG. 1).

Different portions of the emitted beam 40 will intersect planar work surface 60 at different locations. But implementing known methods including the so-called Scheimpflug condition can be used to cause substantially all of the image of interest 50 to remain in focus on the plane of the work surface 60.

FIG. 4A depicts an exemplary optical path for system 30 and system 10, according to an embodiment of the present invention in which optical system 145 includes a collimating lens 142, a substrate 120 with diffractive pattern 130 that provides collimating over a region denoted as 250. Substrate 120 with diffractive pattern 130 on or within the substrate surface may be referred to herein collectively as a diffractive optical element or “DOE”.

In FIG. 4A, focus lens 142 focuses the collimated light rays onto projection surface 60 with the result that a pattern 50, 60 can be seen by a user 80. For ease of illustration, projection surface 60 (on to which virtual image(s) 50, 70 are projected) is shown normal to the axis of optical system 145. In some systems a non-normal configuration, such as represented by surface 60′ (shown in phantom) will be present, in which situation optical element(s) imposing the Scheimpflug condition can be used to minimize distortion arising from the inclined projection surface.

Referring briefly back to FIG. 3, the distance from projection system 30 to the top row of a virtual keyboard 50 (or the nearest portion of another projected image) will be shorter than the distance to the borrow row of the same virtual keyboard (or similar region of another projected image). However projection system 30 can be designed to impose the Scheimpflug condition to render a more sharply-focused projected image 50 upon surface 60. Those skilled in the art will recognize that the Scheimpflug condition is met when the projection plane (e.g., surface 60), the system 30 lens plane and system 30 effective focus plane meet in a line. Additional optical components are not required per se, but rather the design of optical components within system 30 should take into account the distortion that can exist if the Scheimpflug condition is not met.

It is to be understood that while most of the embodiments described herein after are drawn in the figures with projection surface 60 substantially normal to the axis of the relevant optical system, the Scheimpflug condition may be imposed for non-normal projection surfaces.

FIG. 4B depicts an alternative embodiment of system 30 and system 10 in which optical system 145 has a single lens 142 that merges collimating function and focus function into a single element. In some applications it is desirably to also merge the focus-collimating function of lens 142 with the DOE function of element 120 into a single optical element. Understandably the use of fewer discrete optical elements in system 30 can enable overall system 10 to be implemented more readily, especially where small form factor is an important consideration.

Some practical problems associated with implementing a diffractive optical element (DOE) 120, 130 will now be described. It will be appreciated that the dimensions noted earlier herein for L, X1, X2, and W are essentially ergonomically driven: a virtual input device such as a keyboard should be large enough for a user to comfortably view and interact with. From trigonometry it follows that a full deflection angle α≈55° is required, e.g., 55°=arctan [20/squareroot(10²+20²)]. Assume that source 30 emits light with a wavelength≈650 nm. For a large deflection angle α≈55°, a DOE 120, 130 pattern pitch of about 1.3 μm will be required, e.g., /[sin (27)]≈650 nm/0.45=1.3 μm. If the index of refraction for substrate 120 is 1.3, the etch depth of a pattern defined in the substrate will be about 0.9 μm, e.g., 650 nm/[2@(1.3−1)]=0.9 μm.

In practice, it is difficult to fabricate such diffractive optical elements, especially if it is desired to keep fabrication costs and material costs at a minimum. Even diffractive optical elements that substantially meet desired feature size and etch depth tolerance requirements can still exhibit excessive ghosting, bowing, and so-called zero order dot artifacts due to the difficulty in meeting the tight manufacturing tolerances that are required. From a fabrication point of view, it is advantageous to employ DOEs whose deflection angles are smaller than α≈55°. For example, one can economically fabricate high-image quality DOEs having a full deflection angle α≈25°, but an attendant problem is the inability to project as large a user-viewable image 70 as is desired. Projecting the larger user-viewable image dictates α≈55°. Several embodiments will now be described that enable projection of a larger user-viewable image, while using one or more relatively inexpensive and narrow deflection angle DOEs, e.g. α≈19° to 25 E.

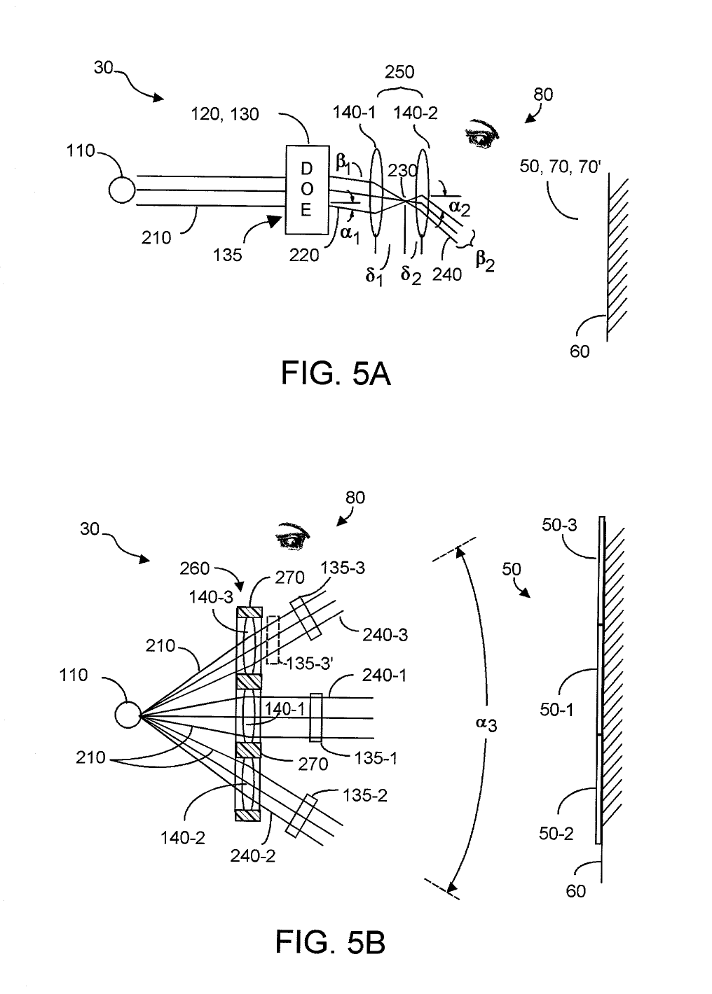

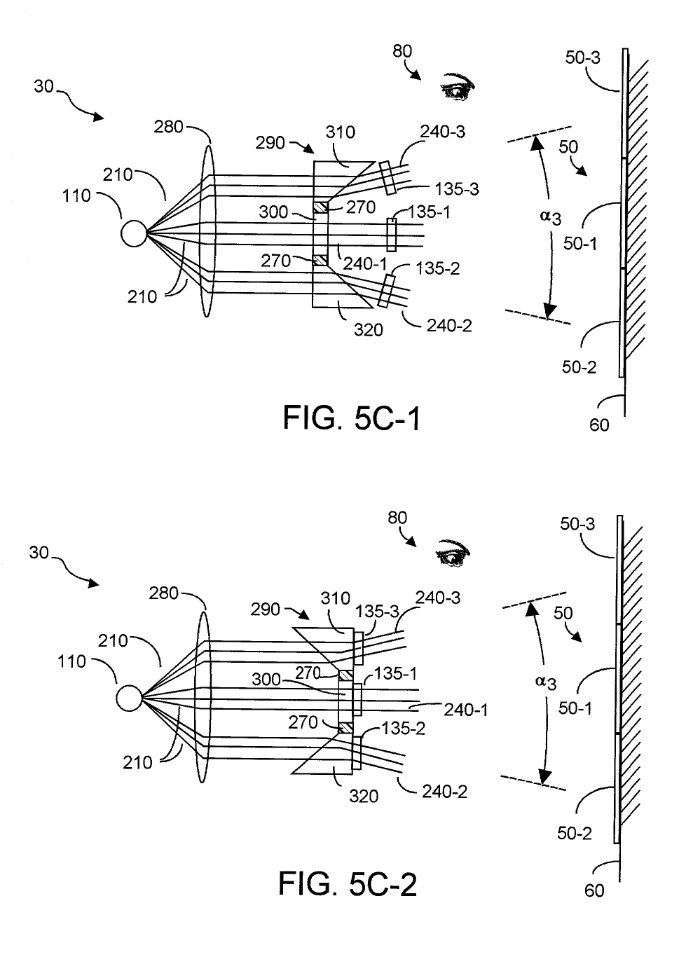

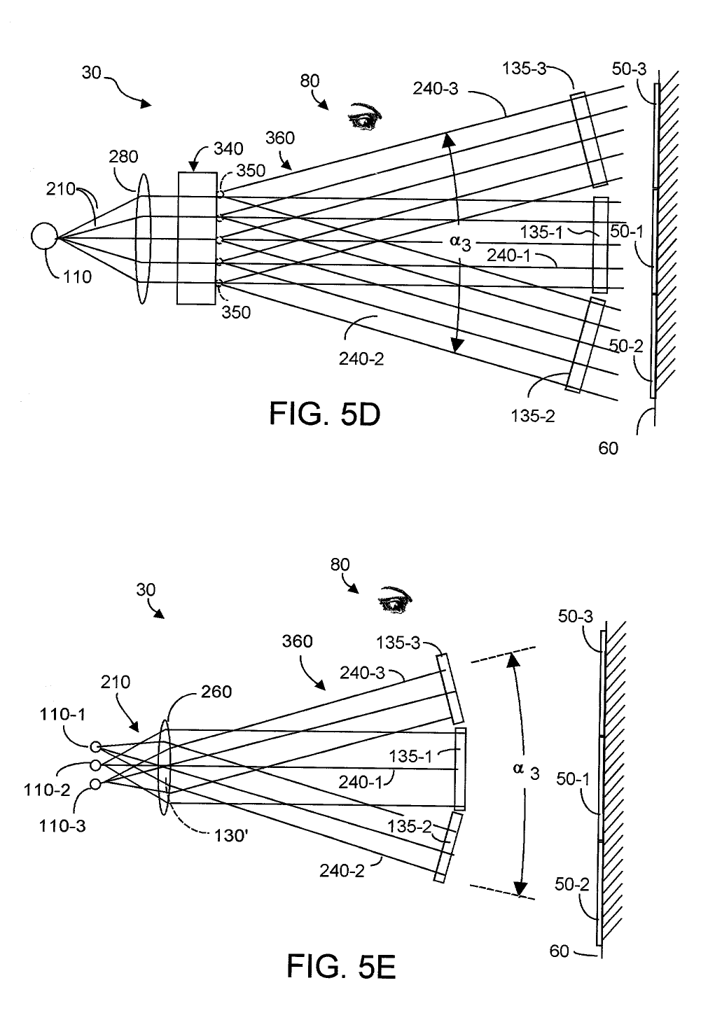

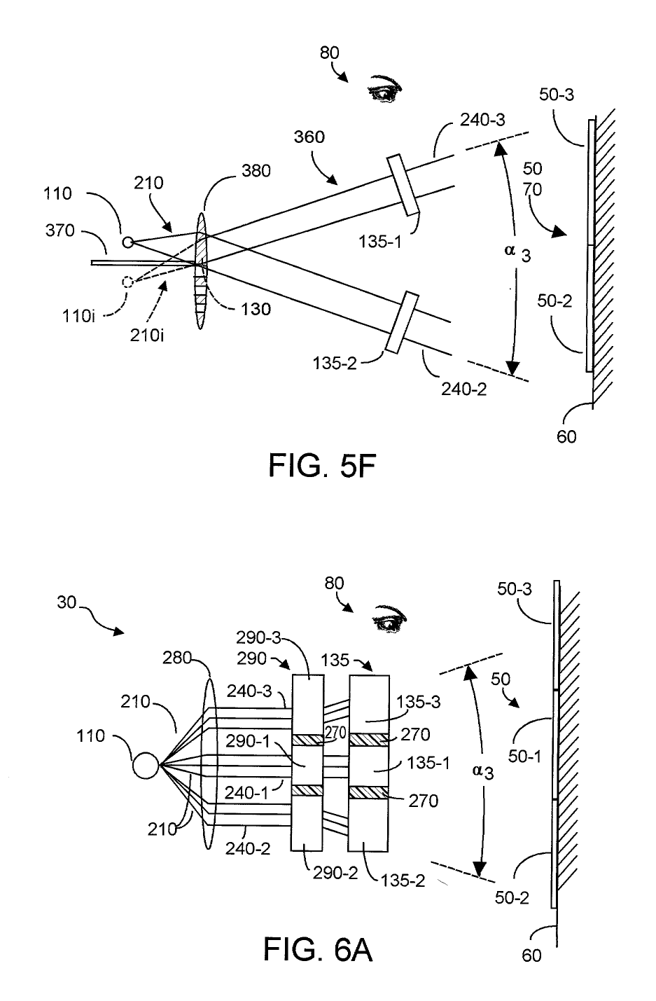

Turning now to FIG. 5A, a beam expanding embodiment is shown in which there is a trade-off between relatively large entry beam width β1 and small deflection angle α1, and relatively narrow exit beam β2 and relatively larger deflection angle α2. The goal of the embodiment shown is to allow use of a relatively inexpensive and readily produced DOE 135, here comprising substrate 120 and pattern 130. However such DOEs are characterized by a relatively narrow deflection angle α1≈19° to 25°, which would result in the projection of a rather small image. What is desired is a DOE with a larger deflection angle α2, for example α2=55°, which would result in a magnified user-viewable image 50, 70, 70′. This desired result is achieved by the configuration shown.

In FIG. 5A, light source 110 emits collimated rays 210 that enter DOE 135 and exit as output rays 220 to be acted upon by a beam expanding unit 250 (here comprising lenses 140-1, 140-2). As noted, if DOE 135 is an inexpensive, readily produced component, it will be characterized by a relatively narrow projection angle α_{1.} System 30 in FIG. 5A magnifies the relatively narrow projection angle α₁ by a ratio proportional to the distances δ1 :δ2, the ratio determined by the geometry associated with the location of common focal point 230 and the distance of each lens 140-1, 140-2 to that focal point. Note that output rays 240 exiting lens 140-2 exhibit a narrower beam width β2 than the width β1 of beams entering lens 140-1, but also exhibit a desired larger deflection angle α₂, for example α₂≈55°. Thus, the embodiment of FIG. 5A advantageously permits use of a relatively inexpensive DOE 135 while creating a larger offset collimated beam. The effect is that the size of the image 50, 70, 70′ projected upon surface 60 is magnified in size as seen by user 80. This large offset collimated beam can then be used to project an image (e.g., 50, 70, 70′) over a large projection angle. The desired result is that a relatively inexpensive narrow angle DOE 134 can be used to radiate light rays 240 through the desired large deflection angle α2 of about 55°.

While the configuration of FIG. 5A magnifies the deflection angle and thus enlarges the size of the projected user-viewable image, (50, 70, 70′), an undesired side effect is that sharpness of the projected image is typically degraded. Further, it is desirable to implement system 30 in a small form factor, and having to provide a lens system 250 comprising spaced-apart lenses 140-1, 140-2 may not always be feasible. Potential solutions to the loss of sharpness in the magnified projected image include using more complex optical components to shrink or expand regions of the image such that sharpness in the projected image is enhanced.

Alternative configurations are possible to project a large deflection angle user-viewable image using narrow deflection angle DOEs. For example, multiple such DOEs may be used, each such DOE generating a portion of the keyboard that involves a projection angle within the somewhat limited projection angle capability of the individual DOE. A separate light source may drive each DOE, or a single light source could be used. Thus, image 50, 70 projected upon surface 60 (see FIG. 3) could be comprised from several sub-images, each sub-image being projected by one embodiment 30, as shown in FIG. 5A. The composite image would appear as a single image to the user-viewer.

Turning now to system 30 shown in FIG. 5B, an alternative embodiment for generating multiple sets of collimated beams from a single light source is shown. However as an alterative to using a single light source for multiple DOEs, multiple light sources may instead be used. In FIG. 5B, light from a single light source 110 passed through a compound optical system 260 that comprises stacked multiple lenses 140-1, 140-2, 140-3, which lenses includes an optically opaque light blocker 270 at each lens end to minimize optical aberration. Light blockers 270 may be portions of the lenses that include an opaque material, or may be physically separate light-opaque components that are attached to the regions of the lenses through which no light transmission is desired. The output from system 260 includes three sets of collimated beams, 240-1, 240-2, 240-3, that are separated, set from set, upon exiting system 260. Each set of collimated light beams is passed at least partially through an associated DOE, e.g., 135-1, 135-2, 135-3.

In the various embodiments described herein, n the surface of, or within (for better protection against damage) the substrate 120 associated with each of the DOE or DOEs will be a pattern 130 that generally will be different for each DOE.

In FIG. 5B, the pattern within DOE 135-3 creates region 50-3 of a user-viewable image 50 upon projection surface 60, for example the left-hand third of the virtual keyboard shown in FIGS. 2 and 3. The pattern within DOE 135-2 is used to create region 50-2 of user-viewable image 50, here the right-hand third of the virtual keyboard shown in FIGS. 2 and 3. Similarly the pattern within DOE 135-1 creates image region 50-1 of the overall mosaic or composite user-viewable image 50, here the central third of the keyboard image shown in FIGS. 2 and 3.

In embodiments including that shown in FIG. 5B where multiple DOEs cooperate to produce an overall image 50, it is permissible that image regions generated by each DOE overlap regions generated by adjacent DOEs, but each pattern of individual virtual keys (e.g., the “A” key, the “S” key, etc.) will be generated using light from a single DOE. This aspect of the invention increases the tolerance for misalignment of the sub-patterns that create the overall image 50.

Thus in FIG. 5B and in various other embodiments described herein, while each individual DOE is typically characterized by a narrow projection angle, the overall composite image 50 is projected over a larger projection angle α3, perhaps 55°, by virtue of the beam separation afford by optical system 260.

Note in FIG. 5B that while DOEs 135-1, 135-2, 135-3 are shown disposed with a central plane normal to the axis of incoming light beams, the DOEs could in fact be rotated, as shown in phantom for DOE 135-3′. An advantage of rotation is that the DOE may in fact be merged into the associated lens, e.g., lens 140-3 could include DOE135-3, to conserve space in which system 30 is implemented. Thus, in FIG. 5B, the left-to-right dimension of system 30 may be compacted, relative to the embodiment of FIG. 5A, which is desirable when including system 30 within a device 20 that itself has a small form factor, e.g., a PDA, a cell phone.

Turning now to FIG. 5C-1, system 30 includes a splitting prism structure 290 that receives collimated light from a single source and outputs multiple sets of collimated beams that are angularly separated for use in projecting an image onto a projection surface 60 over a wide projection angle α3. In the embodiment shown, a single light source 110 emits rays 210 that pass through a collimating system 280, shown here as a lens. The parallel rays that are output from collimating system 280 pass through a splitting prism 290 that includes a central rectangular region 310 triangular end regions 310, 320, and light blocking regions or elements 270. The action of prism 290 is such that while exiting central rays 240-1 are not deflected, collimated light rays 240-2, 240-3 associated with end prism regions 320, 330 are substantially deflected to enable a large projection angle, e.g., α3 . 55 E. Although splitting prism 290 is shown with three distinct regions, a splitting prism having more than three regions could be used. Optically downstream from each set of collimated beams 240-1, 240-2, 240-3 is a DOE element, e.g., 135-1, 135-2, 135-3.

Similar to what was described with respect to FIG. 5B, each set of collimated beams passed at least partially through a DOE, e.g., 135-1, 135-2, 135-3, to create upon projection surface 60 a mosaic user-viewable image 50 that comprises, in this example, sub-images 50-1, 50-2, 50-3. As each sub-image is created with a DOE have a relatively narrow projection angle (e.g., α1. 19-25 E), each sub-image will be projected reasonably sharply, as viewed by user 80.

FIG. 5C-2 is similar to FIG. 5C-1 except that splitter prism 290 has been rotated. As a result, the optically downstream surface of prism 290 is planar, and the functions of DOEs 135-1, 135-2, 135-3 may be physically merged into the prism structure. The result is a savings in form factor, a reduction in the number of separate optical elements, e.g., one instead of four, and a more physically robust system 30.

In “split-DOE” configurations such as exemplified by FIGS. 5B-5C2, an individual DOE is sized about 2 mm×2 mm, with less than perhaps 0.5 mm separation between adjacent DOEs.

FIG. 5D depicts an embodiment useable with a single light source 110 whose rays 210 pass through a collimating optics system 280, shown here as a lens. The collimated light output from collimating optics 280 passes through a DOE unit 340 whose output comprises (in the embodiment shown) three sets of collimated light beams, collectively denoted 360. Again it is understood that within or on DOE 340 is a diffractive pattern that results in the generation of beams 360. Although the beams exiting DOE 340 have immediate angular separation, spatial separation does not occur until some distance optically downstream from DOE 340, perhaps a distance of 5 mm to about 10 mm. Thus, looking at beams 360 immediately adjacent DOE 340 one does not immediately see that there are really three sets of collimated beams, denoted 240-1, 240-2, 240-3. Once spatial separation occurs, each of these sets of collimated and separated beams is presented to an associated DOE, e.g,. DOEs 135-1, 135-2, 135-3, to create reasonably sharply focused sub-images 50-1, 50-2, 50-3 upon projection surface 60. The composite overall image 50 appears to user 80 as a single acceptably large image that is projected over a wide angle α3. While the embodiment of FIG. 5D works, a disadvantage is the relatively larger distance between DOE 340 and the individual DOEs 135-1, 135-2, 135-3 required by the need to achieve spatial separation.

FIG. 5E depicts a projection system 30 in which three light sources 110-1, 110-2, 110-3 output rays 210 that are collimated with a single collimating optic element 260 whose output 360 is multiple sets of collimated beams. Typical separation between adjacent light sources is on the order of about 2 mm. While output beams 360 achieve immediate angular separation, spatial separation occurs further downstream, after perhaps 5 mm to 10 mm. After the separation distance at which the beams become distinctly separate, associated DOEs are introduced to create separate sub-images that are reasonably sharply projected upon surface 60 to create a larger composite image 50. While the configuration of FIG. 5E achieves the desired large angular offset (e.g., α₃. 55 E) desired to present a large image 50, the form factor required is somewhat extended. The extended form factor arises from the need to achieve spatial separation of individual sets of collimated beams 240-1, 240-2, 240-3 before introducing the associated DOEs 135-1, 135-2, 135-3. However, a relatively large overall projection angle α₃ is created, and the overall projected image 50, 70 seen by a user-viewer 80 can be both relatively large and in sharp focus.

An advantage of multi-light source embodiments such as shown in FIG. 5E is that the power output per light source can be less than an overall system having a single but more powerful light source. For example, in a system using three 636 nm LED light sources 110, each of the three light sources outputs about 2 mW, compared to perhaps 7 mW output for a single (but brighter) LED light source. LED light sources 110 emit light that is much less intense than light emitted by a laser diode source 110, and as noted herein LEDs have a rather large emitting area (200 μm×200 μm) in an attempt to compensate somewhat for their lower output intensity. Embodiments such as FIG. 5E in which the light source is implemented using multiple potentially small light sources that can illuminate different DOEs make the problems associated with low light intensity LED sources 100 less severe.

LED light sources 100 present problems associated with the somewhat broad spectrum of emitted light, perhaps a 30 nm or about 5% of the emission wavelength. The deflection angle a of a DOE is proportional to wavelength of the incoming light beams. In an application such as shown in FIG. 3 where the user-viewable image is a virtual keyboard, the keyboard width is about 20 cm, and the light beams creating the image will be deflected by 10 cm on each side of the keyboard image. If light source 110 is an LED, the emission spread translates into about 5%@10 cm . 5 mm, which means an unacceptably large 5 mm blurred spot size at the edges of the keyboard. However by breaking up the DOE function by using several smaller DOEs that each have a smaller deflection angle (e.g., α1. 20 E), the spot spread due to spectral blurring can be reduced to about 1 mm, which size is acceptable.

Thus, while use of LEDs as light source(s) 110 is accompanied by problems associated with large aperture size and spectral spread, the aperture size and spectral spread is substantially in excess of what is required to project a user-viewable image using one or more DOEs. Alternative and better sources exist in the form of LEDs that use stimulated emission to emit brighter light with less spectrum spread, but do not have the rigorous mirrors typically used in lasers employing a Perry fibro cavity. Resonant cavity LEDs (RCLEDs) and possibly superlumiescent LEDs provide adequate light intensity without excessive spectral spreading. Further, because the emitting surface on such light sources is normal to the semiconductor wafer, the device can be completely defined during fabrication. Thus, no further processing steps are required after the wafer is cut into individual LED or VCSEL devices, which promotes substantial economies of scale during fabrication. While VCSEL production can enjoy the same economies of scale, VCSELs are difficult to fabricate with light output in the 630 nm or lower range, although RCLEDs that output 630 nm can be economically produced.

Turning now to FIG. 5F, a pseudo-dual light source embodiment of system 30 uses a single real light source 110 and a half-mirrored surface 370 create a pseudo second light source 110i that is merely a virtual image of the first light source. The real and the virtual light sources are equidistant from half-mirrored surface 370. A half lens 380, e.g., an element whose upper portion (in the configuration shown) functions as a collimating lens but whose lower portion does not, receives real and virtual rays 210, 210i, from real and virtual light sources 110, 110i respectively, and outputs two sets of collimated beams 360 over a relatively large project angle α₃ (e.g., perhaps about 55 E). As shown in FIG. 5F, the two sets of collimated beams 240-2, 240-3 are immediately angularly separated and spatially separated.

An advantage of this pseudo-light source configuration is that there is but one actual light source (110) that consumes power, yet the angle-expanding characteristics of the system are similar to a system with two actual light sources, albeit with slightly less brightness at the user-viewed image. Half lens 380 preferably also includes the diffractive pattern 130 that in the presence of collimated light rays from real and virtual sources 210, 210i projects the user-viewable image 50, 70 upon surface 60. There is no need to provide a true lens function for the virtual rays emanating from virtual or imaginary light source 210i, and thus element 380 may be a half lens, as shown.

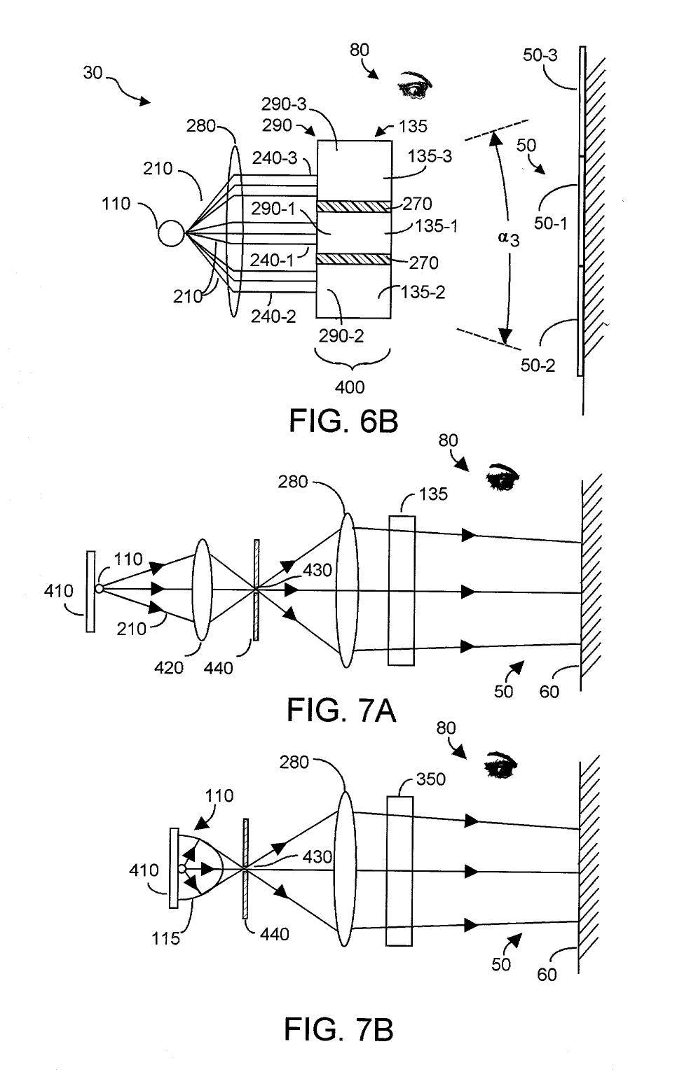

Various embodiments to achieve collimated beam splitting, and angular and spatial separation using separate DOEs have been described above with respect to FIGS. 4A-5F. Two embodiments using one or more composite DOEs to accomplish beam splitting, angular and spatial separation, and/or pattern projection will now be described with reference to FIGS. 6A and 6B.

In FIG. 6A, rays 210 from light source 210 are collimated by optical element 280, and the multiple sets of parallel beams, e.g., 240-1, 240-2, 240-3 are input to respective regions 290-1, 290-2, 290-3 of a first composite DOE element 290. Regions 290-1, 290-2, 290-3 preferably are formed on a common substrate, e.g., substrate such as substrate 120 in FIG. 3, for ease of fabrication. Preferably adjacent such regions are separated by optical blocking elements 270. Light beams exiting DOE 290 exhibit angular and spatial separation immediately. The respective sets of exiting beams enter respective regions 135-1, 135-2, 135-3 of a second composite DOE 135, whose adjacent regions preferably are separated by optical blocking elements 270. DOE 135 contains, preferably on a common substrate, separate patterns that will project respective sub-images 50-1, 50-2, 50-3 upon projection surface 60, to create a large sized composite image 50 over a wide projection angle α3 (e.g., perhaps 55°). Note that the relationship between composite DOE 290 and composite DOE 135 is that DOE 135 region 135-3 only sees light emerging from DOE 290 region 290-3, DOE region 135-2 only sees light emerging from DOE region 290-2, and DOE region 135-1 only sees light emerging from DOE region 290-1. It is understood that if DOE 135 and DOE 290 each defined more or less than three regions, the same relationship noted above would still be imposed.

In the embodiment of FIG. 6B, a single composite merged DOE 400 provides the functionality of DOE 135 and DOE 290, described above with reference to FIG. 6A. In essence, DOE 135 and DOE 290 are fused or merged together into a single optical component 400, that preferably includes optical blocking regions 270. Fusing-alignment is such that only DOE imprint region 290-3 is adjacent to DOE imprint region 135-3, albeit perhaps on opposite sides of the fused substrate, only DOE imprint region 290-2 is adjacent to DOE imprint region 135-2, and so forth. Alternatively, if lithographic techniques used to create DOEs permit, region 290-3 and region 135-3 could share a common surface, as could regions 290-2 and 135-2, 290-1 and 135-1, with their respective surface reliefs combined to produce a single surface DOE substrate with (in this example) thee distinct patterns. In the example shown in FIG. 6B, the patterns would correspond to the left-hand, middle, and right-hand user-viewable portions of a virtual keyboard image.

As noted earlier herein, it can be challenging to project a sharply focused image 50, 70, 70′ upon a projection surface 60 when light source 110 is an LED, device whose emitting area is relatively large at about 200 μm×200 μm. Projecting the image of a virtual keyboard over a distance of about 20 cm using an LED emitter as source 110 would result in a feature size of about [20 cm/1 cm]@200 μm=4 mm. But a 4 mm feature size is too large to permit the user to view an acceptably sharply focused image of a virtual keyboard. As used herein, an acceptably sharply focused projected image should have a feature size on the order of about 1 mm. But maintaining system 30 within a relatively compact form factor makes it somewhat impractical to use collimating lenses (e.g., lens 280) having a focal length much greater than about 1 cm. In practice, the embodiments described herein use lenses with focal lengths of about 2 mm to about 5 mm, excluding LED lenses.

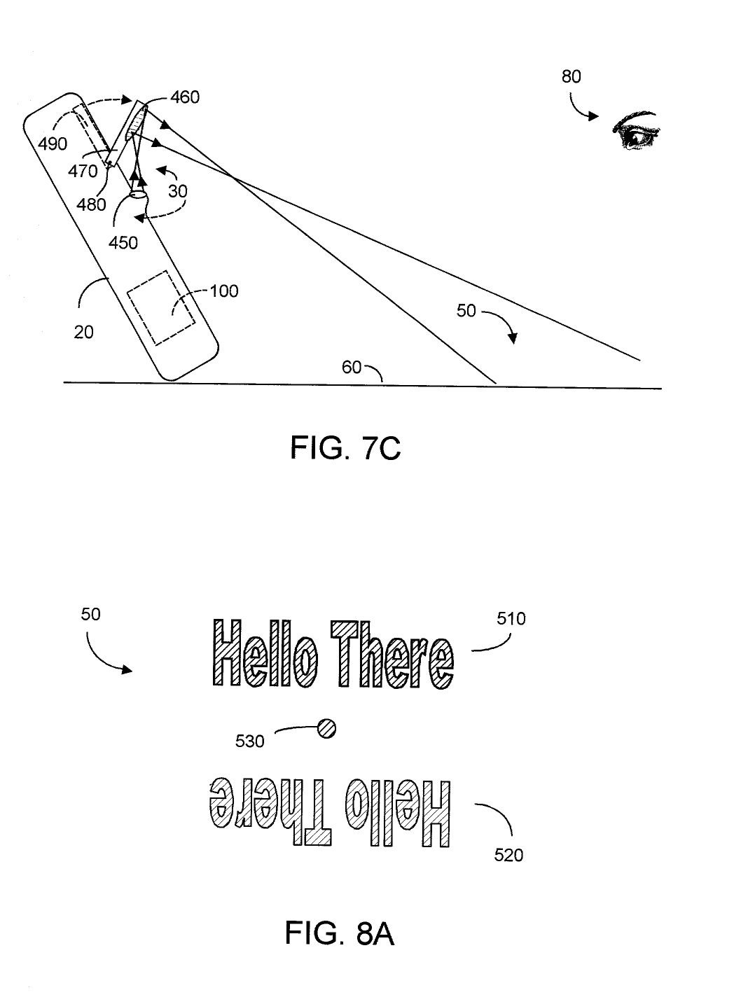

FIGS. 7A and 7B depict two approaches to reduce the effective size of the LED light source 110 such that a smaller feature size can be achieved. In FIG. 7A, light source 110 is a LED shown attached to a semiconductor chip 410 upon which the device may be fabricated. As noted, LED 110 will have a relatively large emitting area. In the embodiment shown, rays 210 from LED 110 pass through an imaging lens 420 to be focused upon an opening 430 defined in a spatial filter 440. In practice, opening 430 will be sized such that projected image 50 has the desired feature size, perhaps about 1 mm. Assume that the emitting area of LED 110 is 200 μm×200 μm and that imaging lens 420 has unity gain. If the spatial filter opening 430 is on the order of 50 μm diameter, the user-viewable image 50 projected upon surface 60 will have the proper feature (or dot) size.

In FIG. 7A, a nearly-collimating element 280 receives incoming light beams via the spatial filter opening and outputs beams that are almost collimated, beams similar to beams 40 in FIG. 4B. These output beams are input to DOE 135 (which may be a compound DOE or other DOE embodiment) whose output is used to project an acceptably sharply focused image 50 upon surface 60. It is understood that DOE 135 and collimating element 280 may in fact be combined or merged. It will be appreciated that collectively optical elements 420 and 280 function as a beam expander.

In FIG. 7B, a more compact embodiment is shown in which LED 110 includes a built-in lens 115 that replaces imaging lens 420 shown in FIG. 7A. LED (imaging) lens 115 can be in direct contact with chip 410, as shown. Thus, in FIG. 7A where a distance of perhaps 2 mm separated LED 110 from imaging lens 410, in the embodiment of FIG. 7B, there is no such separation at all due to the presence of LED lens 115.

FIG. 7C depicts an embodiment of optical system 30 in which the effect of a larger focal length lens is achieved by allowing a portion of system 30 to literally pivot into free air such that a 2 cm or so optical path is achieved in free space. A portion of optical system 30 (indicated by a phantom arrow line) lies within the housing of PDA or other device 20, but a portion of system 30 (indicated by a solid arrow line) can operate in free space, outside of the device housing. Light beams exiting optical device 450, which may include a lens and/or DOEs, traverse an approximately 2 cm length in free air and are reflected from a focusing mirror 460 to be projected upon surface 50 where a user-viewable image 50 will appear. Mirror 460 will preferably also perform a focusing function.

Folding mirror 460 is attached to a member 470 that pivots or otherwise moves about a fastener or axis 480. When device 20 or sensing system 100 is not required, member 470 and mirror 460 can pivot into a recess 490 or the like. But during use, member 470 is hinged clockwise (as shown in FIG. 7C) and into position to direct light beams that form image 50 upon surface 60.

While mechanically somewhat more complex than some of the embodiments shown, the configuration of FIG. 7C functions as though system 30 included a relatively large (e.g., about 2 cm) focal length lens to project the desired user-viewable image.

Various embodiments with which to project user-viewable images over wide diffraction angles have been described. In the presence of wide diffraction angles, problems associated with so-called zero order dot, and with ghosting must also be addressed. As described earlier herein, a DOE receives incoming light beams that are usually collimated or (e.g., FIGS. 7A-7B) nearly collimated, and breaks-up such light into a plurality of output beams that exit the DOE at different diffraction angles. The beams exiting the DOE create the desired user-viewable image upon a projection surface.

But the input light beam cannot ideally be totally suppressed in the output light emerging from the DOE, and the output beams can in practice also include a reduced version of the input. This undesired component in the DOE light output will have the same directional characteristics as the incoming beam and will thus produced a less intense version of the input beam. The result is a bright spot (albeit with reduced power) on the projected image area at the same location and with the same shape as the original light source (e.g., LED 110) would have produced had there been no DOE. This undesired bright spot is called a zero order dot. Even when the zero order dot is less than about 10% of the original input light beam energy, it can still appear distractingly bright in the projected image, and is not safe to the human eye. Thus, suppression of the zero order dot promotes user eye safety in addition to promoting more comfortable user-viewing of the projected image.

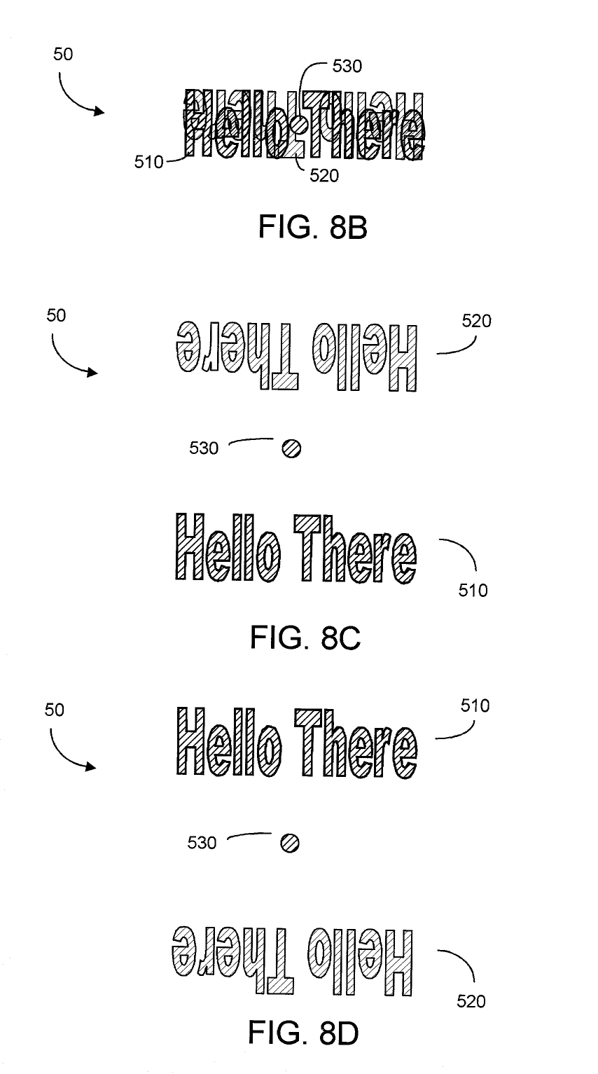

FIG. 8A depicts a user-viewable projected image 50 that presents not only the desired image 510 but a ghost image 520 as well, the ghost image being symmetrical to the desired image with respect to zero order dot 530. As indicated by the bold and not-bold cross hatching, the desired image appears to the viewer as being brighter or more intense than the ghost image, but the ghost image can be visible nonetheless. There will be a ghost image, usually of diminished intensity, for each diffraction angle generated in the output light beams by a DOE. FIG. 8A (as well as FIGS. 8B-8D) assume that projection plane (e.g., surface 50) is normal to the projection optical axis. In the case of a normal projection, typically the zero order dot is in the center of the desired image, as this usually is the case during DOE design, which the result shown in FIG. 8B. If projection surface 60 is slanted, then the zero order dot will not be in the center of the projected image, and the location of the ghost image will have a different size.

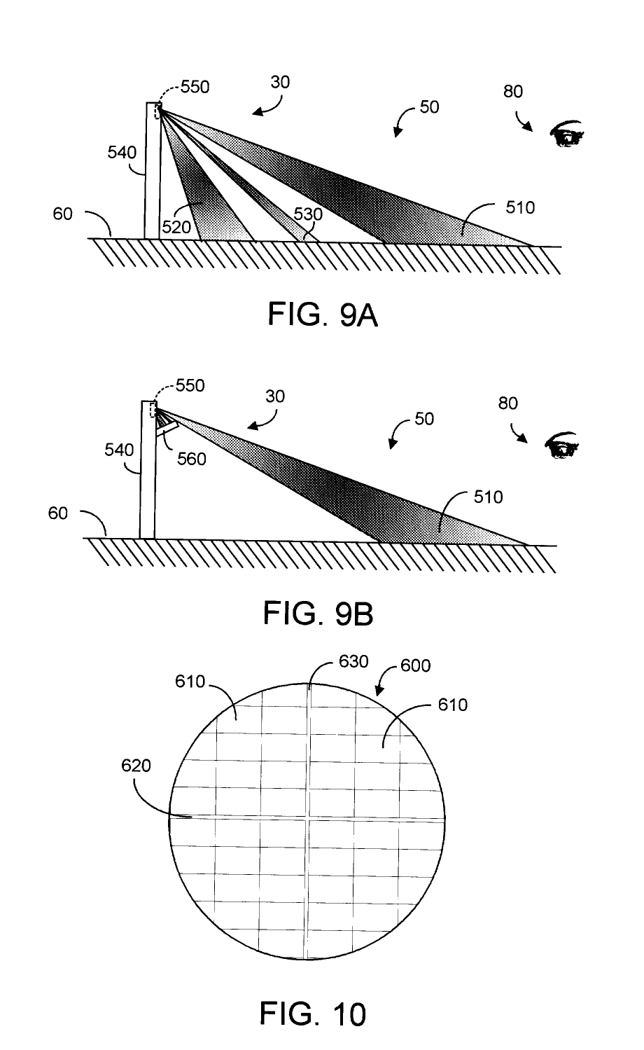

Certain design trade-offs will now be described with respect to FIGS. 8C and 8D. In the improved configuration shown in FIG. 8C, the zero order dot is moved outside the pattern, which increases the magnitude of the required vertical deflection angles. However as the projected image is larger horizontally than vertically, the horizontal deflection angle will be the dominant angle. Further, the required vertical deflection angle is even smaller in that there is a slant to the projection angle required to create image 50 on surface 60, see FIG. 1. In FIG. 8D, the projection plane is slanted (relative to what was shown in FIG. 8C), and the zero order dot and the ghost image appear farther from the desired image 510. In FIG. 8D, the ghost image appears somewhat larger is size but is less intense relative to the configuration of FIG. 8C. In practice, the position of the desired image 510 is fixed on the projection surface, and the position of the ghost image and the zero order dot are preferably selected to satisfy user ergonometric considerations. In the configurations of FIGS. 8C and 8D where the zero order dot appears outside the desired image area, readability of the desired image pattern is enhanced. Advantageously, as the defects in image 50 now appear at locations removed from the desired image, they may be masked out as shown in FIGS. 9A and 9B.

FIG. 9A depicts the projected image 50 including ghost image 520, zero order dot 530, and desired image 510 for the configuration described above with reference to FIG. 8C. As noted, in all likelihood, user 80 will be annoyed if not distracted by the unwanted projection of artifact images 520 and 530 upon surface 50. In FIG. 9A, element 550 is typically a DOE, perhaps DOE 135 in many of the embodiments described earlier herein. Element 550 is shown mounted on or within member 540, associated with optical projection system 30. In FIG. 9B, the addition of an optically opaque obstruction member 560 has the desired effect of interrupting those beams emanating from element 550 that would, if not interrupted, create the undesired ghost image 520 and zero order dot image 530 on projection surface 60. Member 550 may lie within the housing of companion device 20, or may project outwardly. Referring now to FIG. 10, applicants have discovered that DOEs seem not to be mass produced, and that if a substrate 600 is fabricated with a great many DOEs 610 defined on the substrate, following fabrication one does not know where to cut the substrate to break out the individual DOEs 610. Substrate 600 may be about 7 cm in diameter and since a single DOE 610 may be as small as about 5 mm×5 mm (for a single projection DOE), substrate 600 can obviously contain a great many individual DOEs. Applicants have discovered that in defining the various DOEs 610 on substrate 600, it suffices if two preferably orthogonal channels areas 620, 630 are not covered by any DOE patterns whatsoever. The width of each channel is about 0.5 mm. After fabrication, the overall substrate 600 appears “milky” to the eye, but channel areas 620 and 630 will be plainly visible. The DOEs represent a Fourier transform and are periodic on the substrate. Since the relationship between these two channel area to DOEs 610 defined thereon is known, a dicing machine can then be used to accurately cut apart the individual DOEs. Once cut apart, each DOE may be denoted as DOE 135 comprising a pattern or patterns 130 formed on a substrate 120. But for the inclusion of the channel areas 620, 630, one would not know where on the large substrate to begin cutting apart individual DOEs.

While the present invention has been described primarily with respect to projecting images of virtual input devices used to input information to a companion device, it will be appreciated that other applications may also exist.

Although projecting a user-viewable image 50, 70, 70′ using diffractive techniques can be a very efficient in terms of power savings and presenting a bright image, non-diffractive generation techniques may instead be used. For example, separate beams of emitted light might be used to define the perimeter of a user-viewable image, e.g., the outline of a rectangle. Alternatively or in addition, substrate 120 in FIG. 3 might contain the “negative” image of a virtual input device, e.g., a keyboard. By “negative” image it is meant most of the area on substrate 120 would be optically opaque, and regions that would define the outline of the user-viewable image, e.g., individual keys, letters on keys, etc., would be optically transparent. Light from source 110 (which need not be a solid state device) would then pass through the optically transparent outline regions to be projected upon surface 60.

Modifications and variations may be made to the disclosed embodiments without departing from the subject and spirit of the invention as defined by the following claims.

What is claimed is:

1. A system to present an image of a virtual input device for interaction by a user to input information to a companion device, the system comprising:
a source of user-viewable optical energy; and
a diffractive optical element (DOE) including a diffractive pattern that when subjected to energy from said source projects a user-viewable image of said virtual input device.

2. The system of claim 1, wherein said DOE has a deflection angle α;
wherein said system includes means for magnifying said deflection angle a by at least a factor of 1.5.

3. The system of claim 1, further including means for focusing said user-viewable image onto a surface located a finite distance from said system.

4. The system of claim 1, further including means for imposing a Scheimpflug condition upon said system.

5. The system of claim 1, further including a merged optical element to collimate and to focus said source of user-viewable optical energy.

6. The system of claim 1, wherein said source of user-viewable optical energy includes an LED and a collimating element defining an opening smaller than an emitting area of said LED;
wherein feature size of said user-viewable image is improved.

7. The system of claim 1, wherein said source of user-viewable optical energy includes an LED and means for creating a virtual image of said LED;
wherein said system appears to have more than one source of user-viewable optical energy.

8. The system of claim 1, wherein said source of user-viewable optical energy includes at least one of (a) an LED, (b) a laser, and (c) an RCLED.

9. The system of claim 1, further including a reflective element disposed to reflect optical energy to a surface whereon said user-viewable image is viewable;
wherein effective optical focal length of said system is increased by passing at least a portion of said user-viewable optical energy through air prior to reflecting from said reflective element.

10. The system of claim 1, wherein said DOE includes a plurality of diffractive optical elements (DOEs) that, when subjected to said optical energy, project a portion of said user-viewable image.

11. The system of claim 1, wherein said system includes means for splitting optical beams emitted by said source of user-viewable optical energy.

12. The system of claim 10, wherein a projected said portion from one of said DOEs can misaligned with a projected said portion of another of said DOEs without such misalignment being apparent to a user of said system.

13. The system of claim 10, wherein at least two of said DOEs are fabricated on a common substrate.

14. The system of claim 1, further including means for reducing power consumption of said system during intervals when user interaction with said companion device is not required.

15. The system of claim 1, wherein said companion device includes at least one device selected from a group including a PDA and a cellular telephone.

16. The system of claim 1, wherein said user-viewable image is selected from a group consisting of (a) a keypad, (b) a user-manipulatable control, and (c) a keyboard for a musical instrument.

17. The system of claim 1, further including means to diminish a user-visible image resulting from at least one of (a) a ghost image of a desired user-viewable image, and (b) a zero dot image.

18. The system of claim 1, wherein said DOE is one of a plurality of DOEs fabricated on a substrate containing said plurality of DOEs;
wherein during fabrication of said DOEs at least one channel area region is defined that is visibly apparent post-fabrication;
wherein cutting individual ones of said plurality of DOEs is facilitated.

19. The system of claim 1, wherein said source of user-viewable optical energy is pulsed to vary intensity of said user-viewable image.

20. The system of claim 1, wherein said user-viewable optical energy has a wavelength in a range of about 600 nm to about 650 nm.

21. The system of claim 1, wherein said user-viewable image comprises sub-image blocks, wherein chosen ones of said sub-image blocks are not illuminated.

22. A system to present an image of a virtual input device for interaction by a user to input information to a companion device, the system comprising:
a source of user-viewable optical energy; and
an optical system that when subjected to energy from said source projects a user-viewable image of said virtual input device such that power required by said system to project said user-viewable image is proportional to actually illuminated area rather than to total virtual area occupied by said user-viewable image.

23. The system of claim 22, wherein said optical system includes a diffractive optical element (DOE) including a diffractive pattern that when subjected to energy from said source projects a user-viewable image of said virtual input device.

24. The system of claim 23, wherein said DOE has a deflection angle α;
wherein said system includes means for magnifying said deflection angle α by at least a factor of 1.5.

25. The system of claim 22, further including means for focusing said user-viewable image onto a surface located a finite distance from said system.

26. The system of claim 22, further including means for imposing a Scheimpflug condition upon said system.

27. The system of claim 22, further including a merged optical element to collimate and to focus said source of user-viewable optical energy.

28. The system of claim 22, wherein said source of user-viewable optical energy includes an LED and a collimating element defining an opening smaller than an emitting area of said LED;
wherein feature size of said user-viewable image is improved.

29. The system of claim 22, wherein said source of user-viewable optical energy includes an LED and means for creating a virtual image of said LED;
wherein said system appears to have more than one source of user-viewable optical energy.

30. The system of claim 22, wherein said source of user-viewable optical energy includes at least one of (a) an LED, (b) a laser, and (c) an RCLED.

31. The system of claim 22, further including a reflective element disposed to reflect optical energy to a surface whereon said user-viewable image is viewable;
wherein effective optical focal length of said system is increased by passing at least a portion of said user-viewable optical energy through air prior to reflecting from said reflective element.

32. The system of claim 23, wherein said DOE includes a plurality of diffractive optical elements (DOEs) that, when subjected to said optical energy, project a portion of said user-viewable image.

33. The system of claim 22, wherein said system includes means for splitting optical beams emitted by said source of user-viewable optical energy.

34. The system of claim 32, wherein a projected said portion from one of said DOEs can misaligned with a projected said portion of another of said DOEs without such misalignment being apparent to a user of said system.

35. The system of claim 32, wherein at least two of said DOEs are fabricated on a common substrate.

36. The system of claim 22, further including means for reducing power consumption of said system during intervals when user interaction with said companion device is not required.

37. The system of claim 22, wherein said companion device includes at least one device selected from a group including a PDA and a cellular telephone.

38. The system of claim 22, wherein said user-viewable image is selected from a group consisting of (a) a keypad, (b) a user-manipulatable control, and (c) a keyboard for a musical instrument.

39. The system of claim 22, further including means to diminish a user-visible image resulting from at least one of (a) a ghost image of a desired user-viewable image, and (b) a zero dot image.

40. The system of claim 23, wherein said DOE is one of a plurality of DOEs fabricated on a substrate containing said plurality of DOEs;
wherein during fabrication of said DOEs at least one channel area region is defined that is visibly apparent post-fabrication;
wherein cutting individual ones of said plurality of DOEs is facilitated.

41. The system of claim 22, wherein said source of user-viewable optical energy is pulsed to vary intensity of said user-viewable image.

42. The system of claim 22, wherein said user-viewable optical energy has a wavelength in a range of about 600 nm to about 650 nm.

43. A method to present an image of a virtual input device for interaction by a user to input information to a companion device, the method comprising the following steps:
subjecting an optical system to user-viewable energy such that a user-viewable image of said virtual input device is projected upon a surface;
wherein power required by said system to project said user-viewable image is proportional to actually illuminated area rather than to total virtual area occupied by said user-viewable image.

44. The method of claim 43, wherein said optical system includes a diffractive optical element (DOE) that includes a diffractive pattern.

45. The method of claim 43, wherein said DOE has a deflection angle α, and further including magnifying said deflection angle a by at least a factor of 1.5.

46. The method of claim 43, further including imposing a Scheimpflug condition upon said system.

47. The method of claim 42, further including collimating and focusing said source of user-viewable optical energy with a merged optical element.

48. The method of claim 42, further including:
providing a LED as said source of user-viewable optical energy; and
reducing effective emitting area of said LED using a collimating element that defines an opening smaller than actual emitting area of said LED;
wherein feature size of said user-viewable image is improved.

49. The method of claim 42, wherein said source of user-viewable optical energy includes an LED, and further including creating a virtual image of said LED;
wherein said image appears to be generated by more than one source of user-viewable optical energy.

50. The method of claim 42, further including providing as said source of user-viewable optical energy includes at least one of (a) an LED, (b) a laser LED, and (c) an RCLED.

51. The method of claim 42, further including disposing a reflective element to reflect optical energy to a surface whereon said user-viewable image is viewable;
wherein effective optical focal length of said system is increased by passing at least a portion of said user-viewable optical energy through air prior to reflecting from said reflective element.

51. The method of claim 43, wherein said DOE includes a plurality of diffractive optical elements (DOEs) that, when subjected to said optical energy, project a portion of said user-viewable image.

52. The method of claim 42, further including reducing power consumption of said system during intervals when user interaction with said companion device is not required.

53. The method of claim 42, wherein said companion device includes at least one device selected from a group including a PDA and a cellular telephone.

54. The method of claim 42, wherein said user-viewable image is selected from a group consisting of (a) a keypad, (b) a user-manipulatable control, and (c) a keyboard for a musical instrument.

55. The method of claim 42, further including diminishing a user-visible image resulting from at least one of (a) a ghost image of a desired user-viewable image, and (b) a zero dot image.

56. The method of claim 43, wherein said DOE is one of a plurality of DOEs fabricated on a substrate containing said plurality of DOEs;
further including during fabrication of said DOEs defining at least one channel area region that is visibly apparent post-fabrication;
wherein cutting individual ones of said plurality of DOEs is facilitated.

57. The method of claim 42, further including pulsing said source of user-viewable optical energy to vary intensity of said user-viewable image.

58. The method of claim 42, wherein said user-viewable optical energy has a wavelength in a range of about 600 nm to about 650 nm.
